(19) United States
(12) Patent Application Publication
(10) Pub. No.: US 2026/0207312 A1
(43) Pub. Date: Jul. 23, 2026

(54) ELECTRIC TOOTHBRUSH AND DESIGN METHOD THEREOF

(71) Applicant: CIXI SEAGO ELECTRONICS CO., LTD, CIXI (CN)

(72) Inventors: Huiming LIU, CIXI (CN); Yanzhong CAI, CIXI (CN); Weibing PENG, CIXI (CN)

(73) Assignee: CIXI SEAGO ELECTRONICS CO., LTD, CIXI (CN)

(21) Appl. No.: 19/293,439

(22) Filed: Aug. 7, 2025

(30) Foreign Application Priority Data
Jan. 17, 2025 (CN) 2025100799101

(51) Int. Cl. A61C 17/34

(52) U.S. Cl. CPC A61C 17/3472; A61C 17/3481; A61C 17/3454; A61C 17/3463

(57) ABSTRACT

An electric toothbrush comprises a support frame, a drive frame, and a motor. The support frame is provided with a hollow part. The drive frame is elastically connected to the support frame through an elastic arm. The drive frame is positioned in the hollow part. The drive frame is spaced apart from the support frame. An upper end of the drive frame has a drive shaft connector configured to be connected to a toothbrush head. The motor is arranged in the drive frame. An output shaft of the motor is connected with a vibrating hammer. The motor is rotatable to drive the drive frame to swing or vibrate relative to the support frame so that the drive shaft connector can drive the toothbrush head to swing or vibrate. The elastic arm has an effective length calculated by:

$${L}_{s} = {√}^{3} \frac{E b {h}^{3}}{2 k} ,$$

where E denotes a flexural modulus of the elastic arm, b denotes a width of a cross section of the elastic arm, h denotes a height of the cross section of the elastic arm, and k denotes a total stiffness coefficient of the elastic arm.

### CROSS-REFERENCE TO RELATED APPLICATIONS

The present disclosure claims the priority to the Chinese patent application No. 202510079910.1 filed with the Chinese Patent Office on Jan. 17, 2025, and entitled “ELECTRIC TOOTHBRUSH AND DESIGN METHOD THEREOF”, the contents of which are incorporated herein by reference in entirety.

### TECHNICAL FIELD

The present disclosure pertains to the technical field of electric toothbrushes and in particular relates to an electric toothbrush and a design method thereof.

### BACKGROUND ART

In a prior electric toothbrush which generally has a toothbrush head vibrated by an eccentric vibrating motor, the drive mechanism has a large size, a complex structure, and high cost, and there is strong vibration sense and high noise in the toothbrush handle, and the vibration outputted to the toothbrush head is greatly attenuated, which involves high energy consumption.

### SUMMARY

The inventors have found that vibration can be transmitted to the toothbrush head by an elastically connected lever, but there is still room for optimized design of the vibration frequency and amplitude and forces exerted to the toothbrush head.

The present disclosure aims to provide a method for designing an electric toothbrush, which enables a toothbrush head to vibrate efficiently and achieve an expected cleaning effect by optimizing the parameters of an elastic arm.

An embodiment of the present disclosure provides a method for designing an electric toothbrush, wherein the electric toothbrush comprises a support frame, a drive frame, and a motor, and the support frame is provided with a hollow part;
the drive frame is elastically connected to the support frame through an elastic arm, the drive frame is positioned in the hollow part, the drive frame is spaced apart from the support frame, an upper end of the drive frame has a drive shaft connector configured to be connected to a toothbrush head, the motor is arranged in the drive frame, an output shaft of the motor is connected with a vibrating hammer, and the motor is rotatable to drive the drive frame to swing or vibrate relative to the support frame so that the drive shaft connector can drive the toothbrush head to swing or vibrate;
the elastic arm has an effective length calculated by:

$${L}_{s} = {√}^{3} \frac{E b {h}^{3}}{2 k} ,$$

where E denotes a flexural modulus of the elastic arm, b denotes a width of a cross section of the elastic arm, h denotes a height of the cross section of the elastic arm, and k denotes a total stiffness coefficient of the elastic arm.

In at least one possible embodiment, a centrifugal force produced by the vibrating hammer is expressed by F₁, satisfying the following equation:

$${F}_{1} = X ( k - M {ω}^{2} )$$

where M denotes the total mass of the drive shaft connector, the motor, the vibrating hammer, the drive frame, and the toothbrush head connected to the drive shaft connector, X denotes a vibration amplitude of the toothbrush head, and ω denotes an angular velocity of rotation of the motor.

In at least one possible embodiment, a centrifugal force produced by the vibrating hammer is expressed by F₁, satisfying the following equation:

$${F}_{1} = m e {ω}^{2} ,$$

where m denotes the mass of the vibrating hammer, e denotes an eccentricity of the vibrating hammer, and ω denotes an angular velocity of rotation of the motor.

In at least one possible embodiment, the drive shaft connector is connected with a connecting part, the drive shaft connector is connected to the elastic arm through the connecting part, the connecting part surrounds the drive shaft connector, the connecting part has a movable fulcrum, and a distance L₁ from the movable fulcrum to an end portion of the toothbrush head is greater than a distance L₂ from the movable fulcrum to the vibrating hammer.

In at least one possible embodiment, a centrifugal force produced by the vibrating hammer is expressed by F₁, and a force outputted by the toothbrush head is expressed by F₂, where L₁=L₂×(F₂/F₁).

In at least one possible embodiment, the width of the cross section of the elastic arm along a frontward/rearward direction of the electric toothbrush is greater than the height of the cross section of the elastic arm along a leftward/rightward direction of the electric toothbrush.

In at least one possible embodiment, the elastic arm has a flexural modulus of 5,000 MPa to 10,000 MPa.

An embodiment of the present disclosure further proposes an electric toothbrush, which is designed and obtained by using the method for designing an electric toothbrush according to any one of the above-mentioned technical solutions.

In at least one possible embodiment, the drive frame is coupled to the support frame through a connecting part and an elastic arm, the connecting part is connected to the drive shaft connector, the elastic arm(s) is positioned on the left and right sides of the connecting part in a leftward/rightward direction of the electric toothbrush, and the elastic arm is in the shape of a sheet extending along an upward/downward direction and a frontward/rearward direction of the electric toothbrush as a whole.

In at least one possible embodiment, the drive shaft connector, the connecting part, the elastic arm, and the support frame are integrally molded.

According to the above-mentioned technical solutions, the dimensions of the elastic arm are reasonably designed so that the toothbrush head can vibrate efficiently to obtain expected movement characteristics and achieve a better cleaning effect.

### BRIEF DESCRIPTION OF DRAWINGS

FIG. 1 shows an exploded view of a partial structure of an electric toothbrush according to an embodiment of the present disclosure.

FIG. 2 shows a sectional view of a toothbrush handle of an electric toothbrush according to an embodiment of the present disclosure.

FIG. 3 shows a sectional view of the toothbrush handle of an electric toothbrush according to an embodiment of the present disclosure.

FIG. 4 shows a front view of a support frame and a drive frame of an electric toothbrush according to an embodiment of the present disclosure.

### DESCRIPTION OF THE REFERENCE NUMERALS

1 support frame; 11 battery; 12 circuit board; 13 hollow part; 14 waterproof ring; 15 waterproof ring mounting hole;
2 drive frame; 21 drive shaft connector; 22 motor groove; 23 counterweight groove; 24 elastic arm; 25 connecting part; 26 shock absorber mounting groove; 27 first fixed fulcrum; 28 second fixed fulcrum; 29 movable fulcrum;
3 counterweight;
4 pressure-sensitive switch;
5 motor; 51 vibrating hammer;
6 shock absorber;
7 drive shaft;
A upward/downward direction; F frontward/rearward direction; R leftward/rightward direction.

### DETAILED DESCRIPTION OF EMBODIMENTS

In order to more clearly elaborate the above objects, features, and advantages of the present disclosure, specific embodiments of the present disclosure are described in detail herein with reference to the drawings. The present disclosure may be implemented in other different ways in addition to the various embodiments described herein, and those skilled in the art can make corresponding improvements, variations, and replacements without departing from the spirit of the present disclosure, hence the present disclosure is not limited by the specific embodiments disclosed herein. The scope of protection of the present disclosure shall be defined by the claims.

In the following description, an upward/downward direction A of an electric toothbrush represents a direction in which an axis of the electric toothbrush extends, where the upper side represents a side where a toothbrush head is located, and the lower side represents a side where a toothbrush handle is located. A frontward/rearward direction F of the electric toothbrush represents a direction in which bristles of the toothbrush head of the electric toothbrush extend, where the front side represents a side which the bristles are facing, and the rear side represents a side from which the bristles face away. A leftward/rightward direction R of the electric toothbrush is perpendicular to both the upward/downward direction A and the frontward/rearward direction F of the electric toothbrush.

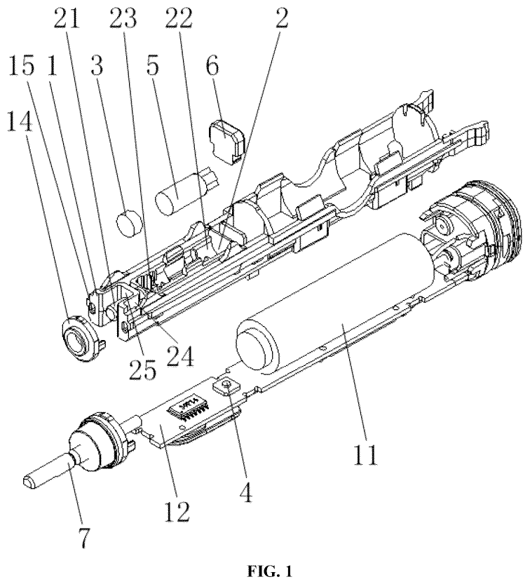

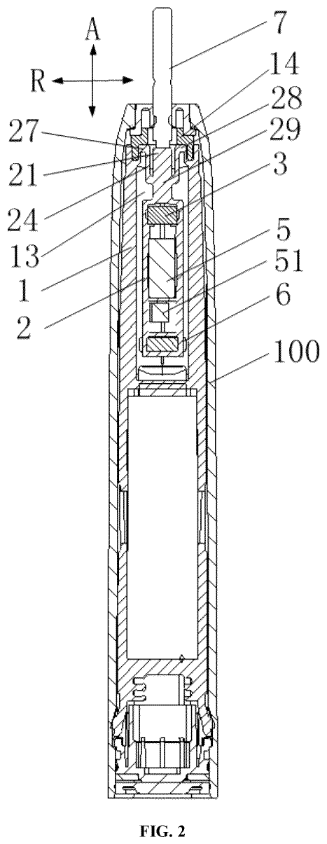

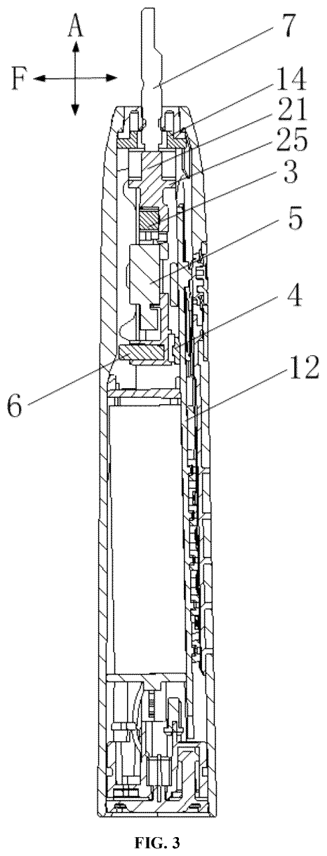

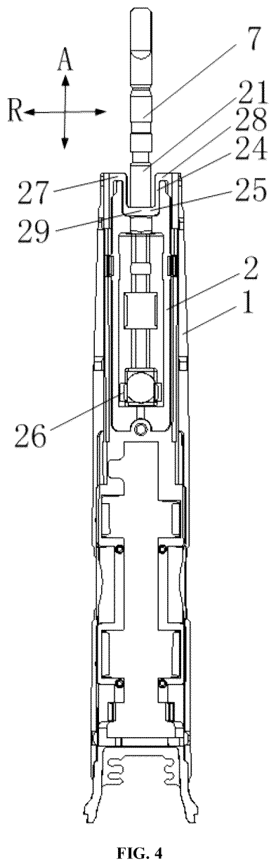

As shown in FIG. 1 to FIG. 4, an embodiment of the present disclosure proposes an electric toothbrush which comprises a toothbrush handle and a toothbrush head (not shown), where the toothbrush handle comprises a main body 100, a support frame 1, a drive frame 2, a counterweight 3, a pressure-sensitive switch 4, a motor 5, a shock absorber 6, and a drive shaft 7. The support frame 1, the drive frame 2, the counterweight 3, the pressure-sensitive switch 4, the motor 5, and the shock absorber 6 can be arranged inside the main body 100, and the drive shaft 7 protrudes from the main body 100 and is configured to be connected to the toothbrush head. The toothbrush head is detachably connected to the drive shaft 7 in a replaceable manner.

The support frame 1 can be configured to allow other components such as a battery 11 and a circuit board 12 to be mounted or fixed thereto, the support frame 1 can be provided with a hollow part 13, the hollow part 13 can be positioned at the middle position of the electric toothbrush in the leftward/rightward direction R, and the hollow part 13 can pass therethrough along the frontward/rearward direction F of the electric toothbrush.

The pressure-sensitive switch 4 can be connected to the circuit board 12, the pressure-sensitive switch 4 is configured to control ON/OFF of the electric toothbrush, and the pressure-sensitive switch 4 allows a user to conveniently control ON and OFF of the electric toothbrush so as to enhance the convenience of user operation and the use experience.

The drive frame 2 can comprise a motor groove 22, and the motor 5 is accommodated in the motor groove 22. The upper side of the drive frame 2 can be connected with a drive shaft connector 21. In the upward/downward direction A of the electric toothbrush, the drive shaft connector 21 can be positioned on the upper side of the motor groove 22. The drive shaft connector 21 can have a cylindrical shape, the drive shaft connector 21 is fixedly connected with the drive shaft 7, and the drive shaft 7 is configured to be connected to the toothbrush head. The drive shaft 7 can be made of a metal material.

The output shaft of the motor 5 is connected with a vibrating hammer 51. The vibrating hammer 51 can have a cylindrical shape. The axis of the vibrating hammer 51 is misaligned with the axis of the motor, so that when the motor 5 drives the vibrating hammer 51 to rotate, a centripetal force can be generated to drive swing or vibration of the drive frame 2. Optionally, the axis of the vibrating hammer 51 can be misaligned with the axis of the motor by a distance (i.e., eccentricity e) of 0.9 mm.

The drive frame 2 can be elastically connected to the support frame 1 through an elastic arm 24. The drive frame 2 can be positioned in the hollow part 13. The drive frame 2 is spaced apart from the support frame 1 as a whole. The motor 5 (and the vibrating hammer 51) can be connected to the drive frame 2. The vibration of the motor 5 can drive the drive frame 2 to swing or vibrate relative to the support frame 1, and then transmit the swing or vibration to the drive shaft connector 21. With the drive frame 2 and the support frame 1 elastically connected and spaced apart from each other as a whole, the toothbrush head connected to the drive shaft 7 can have a certain degree of freedom of movement, so that the toothbrush head can be subjected to forces in different directions, thereby cleaning teeth and massaging gums in a better way.

Specifically, the drive frame 2 can be elastically connected to the support frame 1 through the drive shaft connector 21, a connecting part 25, and the elastic arm 24. The connecting part 25 can be connected to the drive shaft connector 21, and the connecting part 25 can be sheet-shaped. The elastic arm 24 is in the shape of a sheet extending along the upward/downward direction A and the frontward/rearward direction F of the electric toothbrush as a whole, and the two ends of the elastic arm 24 can be bent and connected to the connecting part 25 and the support frame 1, respectively. The connecting part 25 can surround the drive shaft connector 21. The drive shaft connector 21 is connected to the elastic arm 24 through the connecting part 25, the connecting part 25 can be connected to the support frame 1 through two elastic arms 24, and the elastic arms 24 can be positioned on the left and right sides of the connecting part 25 in the leftward/rightward direction R. The connecting part 25 and the elastic arm 24 can have identical dimensions along the frontward/rearward direction F. The connecting part 25 and the elastic arm 24 can be formed as a U-shape, where the connecting part 25 forms the bottom of the U-shape, and the elastic arm 24 comprises two elastic sheets to form the two arms of the U-shape. In the upward/downward direction A, the connecting part 25 can be positioned at the lower end of the elastic arm 24. The elastic sheet can be in the shape of a sheet extending along the upward/downward direction A and the frontward/rearward direction F.

It can be understood that, in other possible embodiments, the elastic arms can also be positioned on the front and rear sides of the connecting part 25 in the frontward/rearward direction.

There is a gap between the drive shaft connector 21 and the elastic arm 24, the drive shaft connector 21 is positioned between the two elastic sheets, and the spacing between the drive shaft connector 21 and the elastic sheet can be 0.5 to 1 millimeter.

The elastic arms 24 can be arranged on the left and right sides of the connecting part 25 in the leftward/rightward direction R. The elastic arm 24 can be in the shape of a bendable sheet, and the dimension (width b) of the sheet-shaped elastic arm 24 along the frontward/rearward direction can be greater than its dimension (height h) along the leftward/rightward direction. Here, the dimension (height h) of the sheet-shaped elastic arm 24 along the leftward/rightward direction is a dimension excluding the spacing between the two elastic arms 24, namely, referring to a solid thickness of the two elastic arms 24. Thus, the elastic arms are likely to undergo bending deformation along the leftward/rightward direction R of the electric toothbrush, but are not likely to undergo bending deformation along the frontward/rearward direction F of the electric toothbrush (they are still deformable). In this way, the drive frame 2 can easily swing relative to the support frame 1 along the leftward/rightward direction, and then drive the toothbrush head to swing or vibrate along the leftward/rightward direction R, thereby cleaning the teeth and/or gums.

It can be understood that the drive shaft 7, the drive shaft connector 21, and the drive frame 2 can be regarded as a rigid rod, and the rigid rod can be used as a lever by the connection of the elastic arm 24 and the support frame 1. Two elastic arms 24 can be provided, and the two elastic arms 24 can be arranged on the two opposite sides of the drive frame 2. The connecting portions between the two elastic arms 24 and the support frame 1 can be used as fulcrums (a first fixed fulcrum 27 and a second fixed fulcrum 28) of the lever. When the lever is swinging relative to the support frame 1, the positions of the first fixed fulcrum 27 and the second fixed fulcrum 28 are fixed relative to the support frame 1.

The drive shaft connector 21 can have a movable fulcrum 29 thereon, and it can be understood that the fulcrum is an artificially defined virtual position, rather than a structurally existing support point. When the motor 5 drives the lever to swing relative to the support frame 1, the position of the movable fulcrum 29 is moved relative to the support frame 1.

A vibration system constituted by the support frame 1, the drive frame 2, the drive shaft connector 21, the connecting part 25, the drive shaft 7, the toothbrush head, and the elastic arm 24 can be simply regarded as a single-degree-of-freedom vibration system. The drive frame 2, the drive shaft connector 21, the connecting part 25, the drive shaft 7, the toothbrush head, the motor, the vibrating hammer, etc. are equivalent to a lever with a concentrated mass of M (approximately 2 g in the present disclosure). The two elastic arms 24 can provide spring characteristics, and the two elastic arms 24 have equivalent stiffness k. The vibrating hammer 51 driven by the motor can provide an excitation force F(t), and the excitation force F(t) is a force exerted on the single-degree-of-freedom vibration system by external excitation that varies with time. The elastic arm 24 can have a flexural modulus of 5,000 MPa to 10,000 MPa.

The single-degree-of-freedom vibration system can be described using a spring-mass-damping system model:

$$M \ddot{x} + c \dot{x} + kx = F ( t ) ,$$

where c is a damping coefficient of the system, which is approximately zero and is negligible. \ddot{X} denotes acceleration, i.e., a rate of change of velocity versus time in the single-degree-of-freedom vibration system, \dot{x} denotes velocity, i.e., a rate of change of displacement versus time in the single-degree-of-freedom vibration system, and x denotes displacement, i.e., an instantaneous offset of the single-degree-of-freedom vibration system relative to the equilibrium position, which is a function of time t.

The vibration amplitude X of the toothbrush head can be estimated by a simplified formula for the spring-mass-damping system, and the vibration amplitude X can be expressed by the following formula:

$$X = \frac{{F}_{1} / k}{1 - {( ω / {ω}_{n} )}^{2}} ,$$

where F₁ denotes a centrifugal force produced by the vibrating hammer, k denotes the equivalent stiffness of the elastic arm, ω denotes an angular velocity of rotation of the motor, and on denotes the natural frequency of the vibration system.

$${ω}_{n} = \sqrt{\frac{k}{M}} ,$$

where the centrifugal force produced by the vibrating hammer 51 is denoted by F₁, and the force outputted by the toothbrush head is denoted by F₂.

$${F}_{1} = m e {ω}^{2} = X ( k - M {ω}^{2} ) ,$$

where the equivalent stiffness k of the elastic arm≈

$$2 {k}_{arm} = 2 \times \frac{3 E I}{{L}_{s}^{3}} .$$

Here, m denotes the mass of the vibrating hammer 51, e denotes the eccentricity of the vibrating hammer 51, and ω denotes the angular velocity of rotation of the motor. ω=2πf, where f denotes the frequency of rotation of the motor, i.e., the number of revolutions per second. For example, the motor has a rotational velocity of 18,000 revolutions per minute (rpm), the motor has a rotation frequency of 300 Hz, and the motor can have an angular velocity of 600π. Kₐᵣₘ is a stiffness coefficient of a single elastic arm, and E is a flexural modulus of the elastic arm; I is the second moment of the cross section of the elastic arm; and Lₛ is the length of the elastic arm.

For example, m can be 0.75 grams, and e can be 0.9 mm, then F₁ is equal to 2.396 Newtons.

The second moment I of the cross section of the elastic arm is equal to

$$\frac{b {h}^{3}}{12} .$$

Here, b denotes the width of the cross section of the elastic arm (dimension along the frontward/rearward direction F), and h denotes the height of the cross section of the elastic arm (dimension along the leftward/rearward direction R). The width b of the cross section of the elastic arm is different from the height h of the cross section of the elastic arm, and the width b of the cross section of the elastic arm is greater than the height h of the cross section of the elastic arm. In the present embodiment, b can be 9.5 millimeters, h can be 1.4 millimeters, the second moment I of the cross section of the elastic arm can be 2.17×10⁻¹², and the flexural modulus of the elastic arm can be 9.6×10⁹ Pa (i.e., 9,600 MPa). In this way, the elastic arm 24 can drive the drive shaft connector 21 to perform elliptical vibration, and further drive the toothbrush head to perform a high-frequency movement for cleaning.

$$\frac{{F}_{1}}{X} = 2 \frac{3 E I}{{L}_{s}^{3}} - M {ω}^{2} ,$$

$$\frac{1}{6 E} = ( \frac{{F}_{1}}{x} + M {ω}^{2} ) = \frac{1}{L {s}^{3}} = \frac{b {h}^{3}}{12 {L}_{s}^{3}} ,$$

The effective length of the elastic arm 24 is calculated by:

$${L}_{s} = {√}^{3} \frac{E b {h}^{3}}{2 k} .$$

In design of the specific structure of the elastic arm 24, the effective length of the elastic arm 24 can be calculated according to the above formula. For example, Lₛ can be 4.5 millimeters. Specifically, the vibration amplitude X of the toothbrush head, the angular velocity ω of rotation of the motor, the mass m of the vibrating hammer 51, the eccentricity e of the vibrating hammer 51, and the flexural modulus E of the elastic arm 24 can be determined first according to actual requirements. In this way, the equivalent stiffness K of the elastic arm 24 can be calculated by F₁=meω²=X(k−Mω²), and then the effective length and cross-sectional area (including the cross-sectional height h and the cross-sectional width b) of the elastic arm 24 are determined.

The distance from the movable fulcrum 29 to the end portion of the toothbrush head is denoted by L₁, the distance from the movable fulcrum 29 to the vibrating hammer 51 is denoted by L₂, and L₁ is greater than L₂, so that the electric toothbrush can have a compact structure.

Specifically, L₁=L₂× (F₂/F₁). For example, F₂ can be set to 0.64 Newtons according to cleaning requirements, and L₂ can be set to 80 millimeters according to the size of the toothbrush head, then L₁ can be calculated to be 21.5 millimeters.

It can be understood that the cross-sectional area of the elastic arm 24 affects the cross-sectional second moment I of the elastic arm 24. If the cross-sectional second moment I increases, the rigidity of the elastic arm 24 is increased, so that the toothbrush head (drive shaft 7) has a decreased vibration amplitude, which is suitable for delicate cleaning. If the cross-sectional second moment I decreases, the rigidity of the elastic arm 24 is decreased, so that the toothbrush head (drive shaft 7) has an increased vibration amplitude, which is suitable for powerful cleaning.

If the effective length Ls of the elastic arm 24 increases, the rigidity of the elastic arm 24 is decreased, so that the toothbrush head (drive shaft 7) has an increased vibration amplitude, which is suitable for powerful cleaning. If the effective length Ls of the elastic arm 24 decreases, the rigidity of the elastic arm 24 is increased, so that the toothbrush head (drive shaft 7) has a decreased vibration amplitude, which is suitable for delicate cleaning.

In other words, the size of the elastic arm 24 directly affects the vibration amplitude of the toothbrush head (drive shaft 7). In the present disclosure, as actually required, the effective length Ls of the elastic arm 24 can be calculated in the case where the cross-sectional area of the elastic arm 24 is known, or the cross-sectional area of the elastic arm 24 can be calculated in the case where the effective length Ls of the elastic arm 24 is known.

Optionally, in this embodiment, the drive shaft connector 21, the elastic arm 24, the connecting part 25, and the support frame can be integrally molded, so that the support frame 1 and the drive frame 2 can have higher overall structural strength and stability.

Optionally, the drive frame 2 can be provided with a counterweight groove 23, the counterweight groove 23 can be positioned on the upper side of the motor groove 22, and the counterweight 3 can be accommodated in the counterweight groove 23. In the upward/downward direction A of the electric toothbrush, the vibrating hammer 51 can be positioned on the lower side of the motor 5, and the counterweight 3 can be positioned on the upper side of the motor 5. The counterweight 3 can increase the overall weight of the drive frame 2 to balance the vibration produced during operation of the motor and avoid imbalance caused by the vibration, so that the electric toothbrush can remain stable during use and that the toothbrush head can move more smoothly and efficiently.

The upper end of the support frame 1 can be provided for example with two waterproof ring mounting holes 15, and the two waterproof ring mounting holes 15 can be arranged on the left and right sides of the drive shaft connector 21 in the leftward/rightward direction R of the electric toothbrush. The waterproof ring mounting holes 15 can be configured to be connected to a waterproof ring 14. The waterproof ring 14 is configured to prevent water or foam from entering the inside of the main body 100.

The shock absorber 6 can be connected to the drive frame 2, at least a part of the shock absorber 6 can be positioned in a gap between the drive frame 2 and the support frame 1, and the shock absorber 6 is elastic. For example, the shock absorber 6 can be made of rubber. When the drive frame is swinging or vibrating, the shock absorber 6 can effectively absorb and alleviate the vibration transmitted to the support frame 1 to weaken the intensity of vibration transmitted to a user's hand, thereby improving comfort of use. For example, the shock absorber 6 can be mounted to the drive frame 2 along the frontward/rearward direction F, and a dimension of the shock absorber 6 along the leftward/rightward direction R is greater than a dimension of the drive frame 2 along the leftward/rightward direction R, so that a part of the shock absorber 6 is positioned in the gap between the drive frame 2 and the support frame 1.

The motor 5 and other components can be protected by cushioning the vibration by the shock absorber 6, and noise generated during operation of the motor 5 can also be reduced, so that the electric toothbrush is quieter during use, and user experience is enhanced. In addition, the shock absorber 6 can also cushion external shocks, reduce damage caused by falls, and thus prolong the service life of the electric toothbrush.

Further, the drive frame 2 can be provided with a shock absorber mounting groove 26, and the shock absorber 6 is mounted in the shock absorber mounting groove 26. In the upward/downward direction of the electric toothbrush, the shock absorber mounting groove 26 can be arranged on the lower side of the motor groove 22, and the shock absorber 6 can be arranged on the lower side of the motor 5.

In use of the electric toothbrush of the present disclosure, a user can turn on the electric toothbrush by the sensitive switch 4 to power it on, so that the motor 5 starts rotating. The vibrating hammer 51 is rotationally driven by the motor 5, so that the drive frame 2 is swung or vibrated about the fulcrum as an axis to transmit power to the drive shaft connector 21, and the drive shaft 7 enables the toothbrush head to swing or vibrate in multiple directions. The drive frame 2 and the toothbrush head are positioned at the two ends of the fulcrum, respectively, and the swing or vibration of the drive frame 2 is amplified at the positions of bristles of the toothbrush head by utilizing the lever principle. Such swing or vibration can effectively clean teeth surfaces and hardly reachable regions to improve the toothbrushing effect.

It should be understood that at least some of the aspects or features of the above embodiments, implementations, or examples can be appropriately combined with each other.

It can be understood that, in the present disclosure, when the number of parts or components is not specifically limited, the number thereof can be one or multiple, where the term “multiple” refers to two or more. In the case where the number of parts or components shown in the drawings and/or described in the description is a specific quantity, such as two, three, or four, the specific quantity is usually exemplary and not restrictive and can be construed as multiple, i.e., two or more, however, this does not mean that the number “one” is excluded in the present disclosure.

In the present disclosure, unless otherwise expressly stated or defined, the terms “mount”, “assemble”, “assembling”, “couple”, “connect”, “link”, “attach”, “abut”, “communicate”, “communicating”, “conduct”, “fix”, “fasten”, and the like should be construed in a broad sense, for example, directly or indirectly. For example, connection can be fixed connection, detachable connection, or integral connection, or can be mechanical connection or electrical connection, or can be direct connection or indirect connection through an intermediate medium, or internal communication between two elements or interaction between two elements, unless otherwise expressly stated or defined. For example, communication/conduction or the like can be direct communication/conduction, or indirect communication/conduction through an intermediate medium. It will be appreciated by those of ordinary skill in the art that the specific meanings of the above terms in the present disclosure can be understood according to specific situations.

In the present disclosure, unless otherwise expressly stated or defined, a component arranged/mounted/positioned/accommodated/disposed in, within, or inside another component can be either of: the component partially or mostly positioned within the another component; and the component wholly accommodated within the another component.

Although the present disclosure is described in detail using the above embodiments, it is apparent to those skilled in the art that the present disclosure is not limited to the embodiments described in this specification. The present disclosure can be modified and implemented as a variant embodiment without departing from the spirit and scope of the present disclosure determined by the claims. Therefore, the description in this specification is for illustrative purposes only and is not intended to limit the present disclosure in any way.

1. A method for designing an electric toothbrush, wherein the electric toothbrush comprises a support frame, a drive frame, and a motor, and the support frame is provided with a hollow part;
the drive frame is elastically connected to the support frame through an elastic arm, the drive frame is positioned in the hollow part, the drive frame is spaced apart from the support frame, an upper end of the drive frame has a drive shaft connector configured to be connected to a toothbrush head, the motor is arranged in the drive frame, an output shaft of the motor is connected with a vibrating hammer, and the motor is rotatable to drive the drive frame to swing or vibrate relative to the support frame so that the drive shaft connector is able to drive the toothbrush head to swing or vibrate,
the elastic arm has an effective length calculated by:
$${L}_{s} = {√}^{3} \frac{E b {h}^{3}}{2 k} ,$$
where E denotes a flexural modulus of the elastic arm, b denotes a width of a cross section of the elastic arm, h denotes a height of the cross section of the elastic arm, and k denotes a total stiffness coefficient of the elastic arm.

2. The method for designing an electric toothbrush according to claim 1, wherein a centrifugal force produced by the vibrating hammer is expressed by F₁, satisfying an equation of:
$${F}_{1} = X ( k - M {ω}^{2} )$$
where M denotes the total mass of the drive shaft connector, the motor, the vibrating hammer, the drive frame, and the toothbrush head connected to the drive shaft connector, X denotes a vibration amplitude of the toothbrush head, and ω denotes an angular velocity of rotation of the motor.

3. The method for designing an electric toothbrush according to claim 1, wherein a centrifugal force produced by the vibrating hammer is expressed by F₁, satisfying an equation of:
$${F}_{1} = m e {ω}^{2}$$
where m denotes the mass of the vibrating hammer, e denotes an eccentricity of the vibrating hammer, and ω denotes an angular velocity of rotation of the motor.

4. The method for designing an electric toothbrush according to claim 1, wherein the drive shaft connector is connected with a connecting part, the drive shaft connector is connected to the elastic arm through the connecting part, the connecting part surrounds the drive shaft connector, the connecting part has a movable fulcrum, and a distance L₁ from the movable fulcrum to an end portion of the toothbrush head is greater than a distance L₂ from the movable fulcrum to the vibrating hammer.

5. The method for designing an electric toothbrush according to claim 4, wherein a centrifugal force produced by the vibrating hammer is expressed by F₁, and a force outputted by the toothbrush head is expressed by F₂, where L₁=L₂×(F₂/F₁).

6. The method for designing an electric toothbrush according to claim 1, wherein a width of a cross section of the elastic arm along a frontward/rearward direction of the electric toothbrush is greater than a height of a cross section of the elastic arm along a leftward/rightward direction of the electric toothbrush.

7. The method for designing an electric toothbrush according to claim 1, wherein the elastic arm has a flexural modulus of 5,000 MPa to 10,000 MPa.

8. An electric toothbrush, designed and obtained by using the method for designing an electric toothbrush according to claim 1.

9. The electric toothbrush according to claim 8, wherein the drive frame is coupled to the support frame through a connecting part and an elastic arm, the connecting part is connected to the drive shaft connector, the elastic arm(s) is positioned on the left and right sides of the connecting part in a leftward/rightward direction of the electric toothbrush, and the elastic arm is in a shape of a sheet extending along an upward/downward direction and a frontward/rearward direction of the electric toothbrush as a whole.

10. The electric toothbrush according to claim 9, wherein the drive shaft connector, the connecting part, the elastic arm, and the support frame are integrally molded.

11. An electric toothbrush, designed and obtained by using the method for designing an electric toothbrush according to claim 2.

12. An electric toothbrush, designed and obtained by using the method for designing an electric toothbrush according to claim 3.

13. An electric toothbrush, designed and obtained by using the method for designing an electric toothbrush according to claim 4.

14. An electric toothbrush, designed and obtained by using the method for designing an electric toothbrush according to claim 5.

15. An electric toothbrush, designed and obtained by using the method for designing an electric toothbrush according to claim 6.

16. An electric toothbrush, designed and obtained by using the method for designing an electric toothbrush according to claim 7.
